(19) United States
(12) Patent Application Publication
(10) Pub. No.: US 2011/0014884 A1
(43) Pub. Date: Jan. 20, 2011

(54) WIRELESS MULTI-CARRIER CODE DIVISION MULTIPLEXING COMMUNICATION APPARATUS USING TRANSMIT DIVERSITY SCHEME

(75) Inventors: Taegyun Noh, Daejeon (KR); Young Jo Ko, Daejeon (KR); Jae Young Ahn, Daejeon (KR)

Correspondence Address: NELSON MULLINS RILEY & SCARBOROUGH LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/920,533

(22) PCT Filed: Mar. 26, 2009
(86) PCT No.: PCT/KR09/01552

§ 371 Date: Sep. 1, 2010

(30) Foreign Application Priority Data
Mar. 27, 2008 (KR) 10-2008-0028226

(51) Int. Cl. H04B 7/02

(52) U.S. Cl. 455/101

(57) ABSTRACT

Provided is a wireless multi-carrier code division multiplexing communication apparatus that may transmit data using a transmit diversity scheme. A transmission apparatus may include: a space-time coding unit to perform space-time encoding of transmission data to generate a plurality of data streams; a radio resource code generation unit to generate a radio resource code vector by referring to radio resource allocation information associated with a reception apparatus; a signal generation unit to generate a plurality of code division multiplexing signals corresponding to a plurality of transmit antennas, respectively, by multiplying the radio resource code vector and the plurality of data streams; and a transmission unit to transmit the plurality of code division multiplexing signals to the reception apparatus via the plurality of transmit antennas. Accordingly, it is possible to effectively transmit data using a transmit diversity scheme in a wireless multi-carrier code division multiplexing communication system.

### TECHNICAL FIELD

The present invention relates to a radio communication system, and more particularly, to a wireless multi-carrier code division multiplexing communication apparatus that may transmit data using a transmit diversity scheme.

### BACKGROUND ART

A transmit diversity scheme denotes a scheme that may transmit data using a plurality of transmit antennas. Data transmitted using each of the transmit antennas may pass through independently changing radio channels. Accordingly, it is possible to enhance a reliability for the data and a transmission efficiency of a data transmission system.

A wireless multi-carrier code division multiplexing communication scheme is generated by combining a code division multiplexing communication scheme and a multi-carrier transmission scheme. In the conventional wireless multi-carrier code division multiplexing communication scheme, it is assumed that data may be transmitted using only a single transmit antenna.

Accordingly, there is a need for a method that may generated data to be transmitted using a plurality of transmit antennas, when a transmit diversity scheme is used for a wireless multi-carrier code division multiplexing communication system.

### DISCLOSURE OF INVENTION

### Technical Problem

An aspect of the present invention provides a method that may generate data to be transmitted using a plurality of transmit antennas when a transmit diversity scheme is used for a wireless multi-carrier code division multiplexing communication system.

### Technical Solution

According to an aspect of the present invention, there is provided a transmission apparatus including: a space-time coding unit to perform space-time encoding of transmission data to generate a plurality of data streams; a radio resource code generation unit to generate a radio resource code vector by referring to radio resource allocation information associated with a reception apparatus; a signal generation unit to generate a plurality of code division multiplexing signals corresponding to a plurality of transmit antennas, respectively, by multiplying the radio resource code vector and the plurality of data streams; and a transmission unit to transmit the plurality of code division multiplexing signals to the reception apparatus via the plurality of transmit antennas.

According to another aspect of the present invention, there is provided a transmission apparatus including: a grouping unit to determine, with respect to a reception apparatus accessing the transmission apparatus, a reception apparatus group including the transmission apparatus; a space-time coding unit to perform space-time encoding of transmission data associated with the reception apparatus to generate a plurality of data streams corresponding to a plurality of transmit antennas, respectively; a first radio resource code generation unit to allocate a first radio resource to the reception apparatus group and to generate a first radio resource code vector by referring to the first radio resource; a second radio resource code generation unit to allocate a different second radio resource to each of the reception apparatus and a second reception apparatus that are included in the reception apparatus group, and to generate second radio resource code matrices by referring to the second radio resource; a signal generation unit to generate a plurality of code division multiplexing signals corresponding to the plurality of transmit antennas, respectively, by multiply the plurality of data streams by the first radio resource code vector and the second radio resource code matrices associated with the reception apparatus; and a transmission unit to transmit the plurality of code division multiplexing signals to the reception apparatus via the plurality of transmit antennas.

According to still another aspect of the present invention, there is provided a reception apparatus included in a reception apparatus group, the reception apparatus including: a reception unit to receive, from a transmission apparatus, a first radio resource code vector that is determined according to the reception apparatus group, and a second radio resource code matrix that is determined to be different from a second reception apparatus belonging to the reception apparatus group, and to receive a code division multiplexing signal that is transmitted via each of a plurality of transmit antennas of the transmission apparatus; and a decoding unit to decode the code division multiplexing signal based on the first radio resource code vector and the second radio resource code matrix. The code division multiplexing signal may be generated by multiplying the first radio resource code vector and the second radio resource code matrix by a plurality of data streams that are generated by performing space-time encoding of transmission data associated with the reception apparatus.

### Advantageous Effects

According to embodiments of the present invention, it is possible to effectively transmit data using a transmit diversity scheme in a wireless multi-carrier code division multiplexing communication system.

### BRIEF DESCRIPTION OF DRAWINGS

FIG. 1 is a block diagram illustrating a structure of a transmission apparatus according to an embodiment of the present invention;

FIG. 2 illustrates an example of generating data to be transmitted using a plurality of antennas when a one-dimensional code division multiplexing scheme is used according to an embodiment of the present invention;

FIG. 3 is a block diagram illustrating a structure of a transmission apparatus according to another embodiment of the present invention;

FIG. 4 illustrates an example of generating data to be transmitted using a plurality of antennas when a two-dimensional code division multiplexing scheme is used according to an embodiment of the present invention;

FIG. 5 illustrates an example of generating a radio resource code matrix associated with a second radio resource when a two-dimensional code division multiplexing scheme is used according to an embodiment of the present invention; and

FIG. 6 is a block diagram illustrating a structure of a terminal to receive data transmitted using a code division multiplexing scheme according to an embodiment of the present invention.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

A wireless multi-carrier code division multiplexing communication system denotes a communication system that enables a plurality of users to share radio resources, allocated to the wireless multi-carrier code division multiplexing communication system, and to thereby transmit data. For example, the radio resources may use a time slot for transmitting a code division multiplexing signal or a frequency band for transmitting the code division multiplexing signal.

A transmission apparatus may group a reception apparatus using a different radio resource that is allocated thereto. It is referred to as “code division multiplexing”. When the present invention is applied to an uplink of a mobile communication system, the transmission apparatus may correspond to a terminal and the reception apparatus may correspond to a base station. Also, when the present invention is applied to a downlink of the mobile communication system, the transmission apparatus may correspond to the base station and the reception apparatus may correspond to the terminal.

When the wireless multi-carrier code division multiplexing communication system performs code division multiplexing for only any one radio resource between the time slot and the frequency band to thereby transmit data, it may be referred to as “one-dimensional code division multiplexing”. When the wireless multi-carrier code division multiplexing communication system performs code division multiplexing for both the time slot and the frequency band, it may be referred to as “two-dimensional code division multiplexing”.

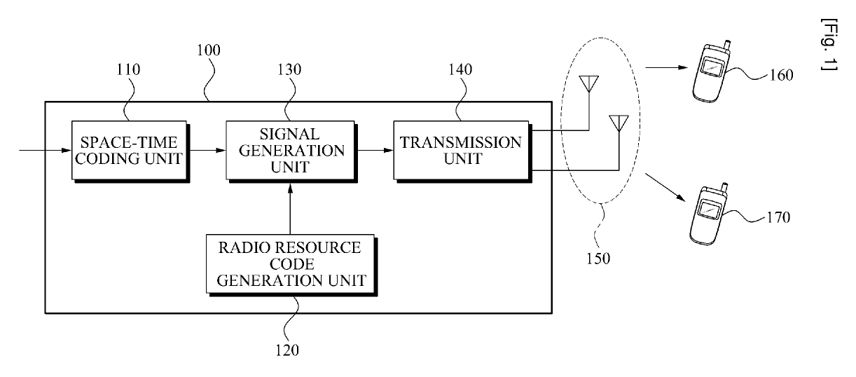

FIG. 1 is a block diagram illustrating a structure of a transmission apparatus 100 according to an embodiment of the present invention. The transmission apparatus 100 may include a space-time coding unit 110, a radio resource code generation unit 120, a signal generation unit 130, and a transmission unit 140. The transmission apparatus 100 may transmit data using a one-dimensional code division multiplexing. Reception apparatuses 160 and 170 may receive the data.

The space-time coding unit 110 may perform space-time encoding of transmission data to be transmitted to the reception apparatuses 160 and 170 and thereby generate a plurality of data streams. The space-time coding unit 110 may perform space-time encoding of the transmission data using an alamouti coding scheme. The plurality of data streams may be orthogonal to each other. Also, the plurality of data streams may correspond to a plurality of transmit antennas included in a transmit antenna unit 150, respectively.

Radio resources may be divided into a plurality of blocks and thereby be managed. Hereinafter, the above block will be referred to as a physical resource block. Information associated with the physical resource block used by each of the reception apparatuses 160 and 170 may directly or indirectly include radio resource allocation information.

A radio resource code may be transmitted via each of a plurality of radio resources, for example, a plurality of orthogonal frequency division multiplex (OFDM) symbols or a plurality of subcarriers. Accordingly, the radio resource code may be referred to as a radio resource code vector.

The radio resource code generation unit 120 may generate the radio resource code vector by referring to radio resource allocation information. When the transmission apparatus 100 transmits data using a one-dimensional code division multiplexing scheme, a different radio resource code vector may be allocated to each of the reception apparatuses 160 and 170. When physical resource block information included in the radio resource allocation information of the reception apparatus 160 is different from physical resource block information included in the radio resource allocation information of the reception apparatus 170, the same radio resource code vector may be allocated to the reception apparatuses 160 and 170.

The signal generation unit 130 may generate a plurality of code division multiplexing signals by multiplying the radio resource code vector and the plurality of data streams. Each of the code division multiplexing signals may be mapped in a particular physical resource block by referring to the radio resource allocation information. Since the plurality of data streams corresponds to the plurality of transmit antennas included in the transmit antenna unit 150, respectively, the plurality of code division multiplexing signals generated based on the plurality of data streams may correspond to the plurality of transmit antennas, respectively.

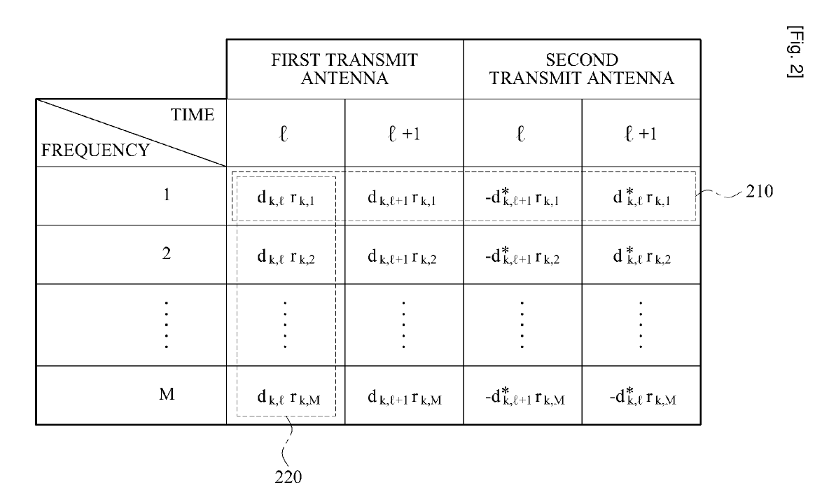

Hereinafter, an operation of the signal generation unit 130 will be described in detail with reference to FIG. 2.

The transmission unit 140 may transmit the code division multiplexing signals to the reception apparatuses 160 and 170 using the plurality of transmit antennas included in the transmit antenna unit 150.

FIG. 2 illustrates an example of generating data to be transmitted using a plurality of antennas when a one-dimensional code division multiplexing scheme is used according to an embodiment of the present invention.

Referring to FIG. 2,

d_{k,l}

denotes data to be transmitted to a k^{th} terminal in an l^{th} time slot.

d_{k,l+1}

denotes data to be transmitted to the k^{th} terminal in an (l+1)^{th} time slot.

rₖ=[r_{k,1}, . . . , r_{k,M}]^{T}

denotes a radio resource code vector with respect to the k^{th} terminal. FIG. 2 illustrates an example of multiplexing frequency resources to transmit data and thus the radio resource code vector includes information associated with a frequency usage of the k^{th} terminal. M denotes a length of the radio resource code vector. In the example of FIG. 2, M denotes a number of frequency bands.

In FIG. 2, referring to data 210 that are transmitted using a particular radio resource, when data

d_{k,l}

and

d_{k,l+1}

to be transmitted via a first transmit antenna in a particular frequency band are compared with data

−d*_{k,l}

and

d*_{k,l+1}

to be transmitted via a second transmit antenna, the data

−d*_{k,l}

and

d*_{k,l+1}

to be transmitted via the second transmit antenna may be generated by performing alamouti coding of the data

d_{k,l}

and

d_{k,l+1}

to be transmitted via the first transmit antenna.

Although FIG. 2 illustrates an example of generating, by the space-time coding unit 110 of FIG. 1, a data stream using the alamouti coding scheme, the present invention is not limited thereto. Specifically, the space-time coding unit 110 may adopt another coding scheme that may generate a plurality of orthogonal data streams.

When data is transmitted using a one-dimensional code division multiplexing scheme, data to be transmitted using each radio resource may be transmitted in a form where a radio resource code vector is multiplied with data to be transmitted each terminal. Specifically, referring to other data 220 that are transmitted using a first transmit antenna in the l^{th} time slot, the data

d_{k,l}

to be transmitted via the first transmit antenna in the l^{th} time slot is multiplied with a radio resource code vector

rₖ

. Other data to be transmitted using another transmit antenna or in another time slot may be generated using a similar scheme.

Specifically, when code division multiplexing is performed in only a particular radio resource, for example, a frequency band, and a plurality of transmit antennas is used, a radio resource code vector allocated to each terminal may be multiplied with data transmitted via each antenna. Since data transmitted using a plurality of transmit antennas are generated to be orthogonal to each other, a transmit diversity gain may be readily obtained.

Referring to FIG. 2, a transmission apparatus may perform space-time encoding of data in a time domain and transmit the space-time encoded data using a multiplexed frequency band. According to another embodiment of the present invention, the transmission apparatus may perform space-time encoding of data in a frequency domain and transmit the space-time encoded data using a multiplexed time slot.

In the example of FIG. 2, a space-time coding scheme may not be applied to data to be transmitted via the first transmit antenna. Specifically, there is no need to correct a data transmission scheme using a conventional single transmit antenna, in order to apply the present invention. A transmit diversity gain may be obtained by additionally installing a second transmit antenna and by generating data to be transmitted via the second transmit antenna. Since conventional equipments may be used as much as possible, it is possible to enhance a data transmission efficiency using relatively less costs and time.

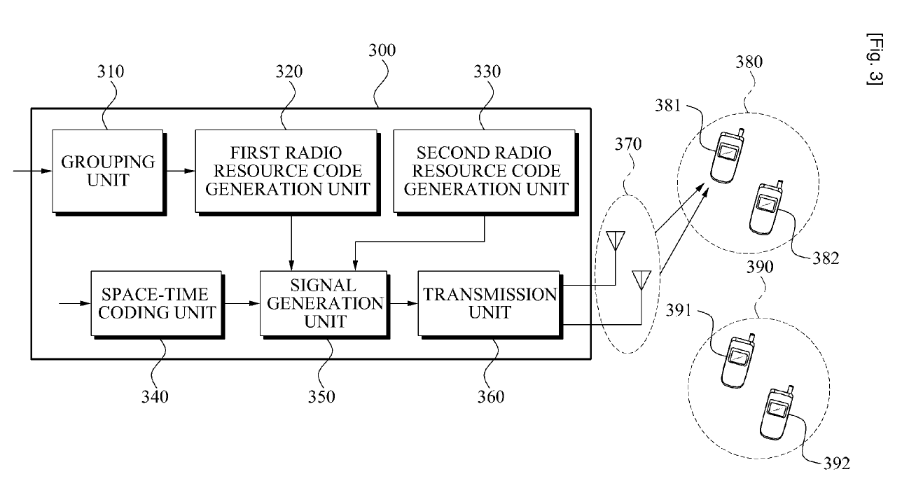

FIG. 3 is a block diagram illustrating a structure of a transmission apparatus 300 according to another embodiment of the present invention. The transmission apparatus 300 may perform two-dimensional code division multiplexing of a radio resource to transmit data. When the present invention is applied to a downlink, the transmission apparatus 300 may correspond to a base station. Each of a plurality of reception apparatuses 381, 382, 391, and 392 may correspond to a terminal accessing the base station. Also, when the present invention is applied to an uplink, the transmission apparatus 300 may correspond to the terminal. Each of the reception apparatuses 381, 382, 391, and 392 may correspond to the base station. Hereinafter, for ease of description, the present invention will be described assuming that the present invention is applied to the downlink. Accordingly, the transmission apparatus 300 is referred to as the base station, and the reception apparatuses 381, 382, 391, and 392 are referred to as the terminals.

A space-time coding unit 340 may perform space-time encoding of transmission data associated with the terminals 381, 382, 391, and 392 to generate a plurality of data streams corresponding to a plurality of transmit antennas, respectively. The space-time coding unit 340 may generate the plurality of data streams using a space-time coding scheme that may generate a plurality of orthogonal data streams, for example, an alamouti coding scheme and the like.

A grouping unit 310 may group the terminals 381, 382, 391, and 392, accessing the base station 300, into a plurality of terminal groups 380 and 390. Specifically, the grouping unit 310 may determine the terminal group 380 or 390 where each of the terminals 381, 382, 391, and 392 are included.

A first radio resource code generation unit 320 may allocate a first radio resource with respect to the plurality of terminal groups 380 and 390, and may generate a first radio resource code vector by referring to the allocated first radio resource. Accordingly, the terminals 381 and 382 grouped into a particular terminal group, for example, the group 380 may share the same first radio resource code vector. The first radio resource code vector is generated based on only information associated with the first radio resource code. In this instance, the terminals 381 and 382 included in the terminal group 380 may include the same physical resource block information or may include different physical resource block information.

According to an embodiment of the present invention, the first radio resource may include information associated with a time slot for transmitting a code division multiplexing signal or a frequency band for transmitting the code division multiplexing signal.

A second radio resource code generation unit 330 may allocate a second radio resource to the terminals 381 and 382 included in the particular terminal group, for example, the terminal group 380. Also, the second radio resource code generation unit 330 may generate a second radio resource code matrix associated with each of the terminals 381 and 382 by referring to the allocated second radio resource. The second radio resource code matrices may include information associated with the allocated second radio resource and information associated with the first radio resource.

For example, rows of a second radio resource code matrix associated with a particular terminal may correspond to a plurality of transmit antennas, respectively. Here, each of the rows corresponding to the transmit antennas may be differently determined. According to an embodiment of the present invention, the rows corresponding to the transmit antennas may be orthogonal to each other.

According to another embodiment of the present invention, a correlation value of each of the rows may be less than or equal to a predetermined reference value. Here, the correlation value indicates how similar two rows are. When the correlation value of the two rows is zero, the two rows are orthogonal to each other. Accordingly, two rows included in a second radio resource code matrix associated with a particular terminal may be determined to be similar to each other.

As another example, with respect to a first terminal and a second terminal included in the same terminal group, rows of second radio resource code matrices may be orthogonal to each other. Specifically, rows of the second radio resource code matrix associated with the first terminal may be orthogonal to rows of the second radio resource code matrix associated with the second terminal.

According to still another embodiment of the present invention, a correlation value of each of rows of a second radio resource code matrix associated with a first terminal and a correlation value of each of rows of a second radio resource code matrix associated with a second terminal may be less than or equal to a predetermined reference value.

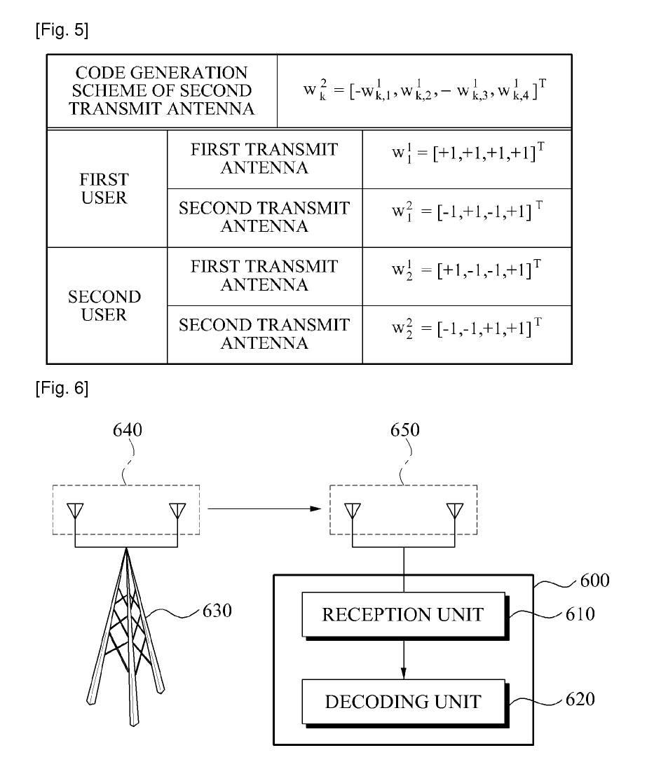

An example of generating, by the second radio resource code generation unit 330, a row of a second radio resource code matrix will be described in detail with reference to FIG. 5.

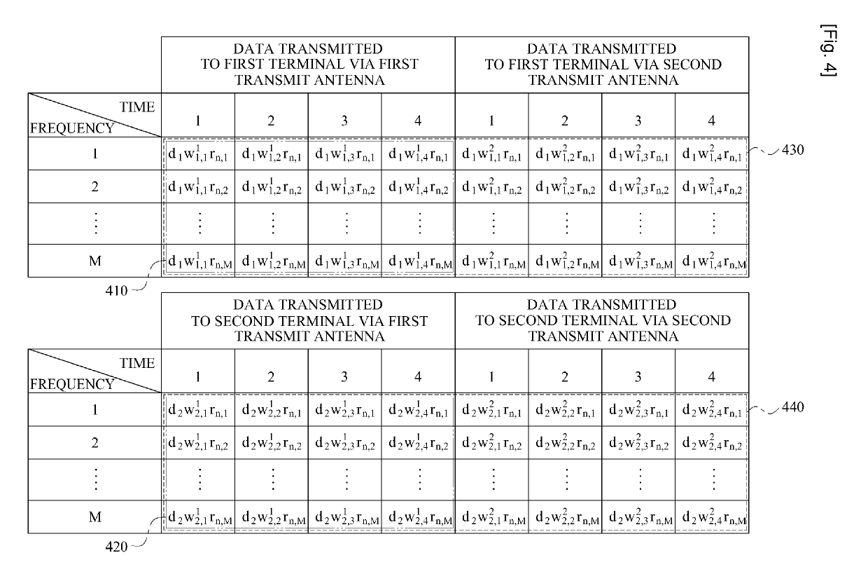

A signal generation unit 350 of FIG. 3 may generate a plurality of code division multiplexing signals corresponding to a plurality of transmit antennas, respectively, by multiplying a data stream associated with a particular terminal by a first radio resource code vector and a second radio resource code matrix. In this instance, the plurality of code division multiplexing signals corresponding to the plurality of transmit antennas of the particular terminal may include the same physical resource block information, or may include different physical resource block information. The plurality of code division multiplexing signals corresponding to the plurality of transmit antennas may be mapped in the same physical resource block by referring to the radio resource allocation information, or may be mapped in different physical resource blocks, respectively. An example of the code division multiplexing signals generated by the signal generation unit 350 will be described in detail with reference to FIG. 4.

A transmission unit 360 may transmit the plurality of generated code division multiplexing signals to the terminals 381, 382, 391, and 392 via the plurality of transmit antennas included in a transmit antenna unit 370.

FIG. 4 illustrates an example of generating data to be transmitted using a plurality of antennas when a two-dimensional code division multiplexing scheme is used according to an embodiment of the present invention.

Referring to FIG. 4,

d₁

denotes data to be transmitted to a first terminal, and

d₂

denotes data to be transmitted to a second terminal.

r_{n,m}

indicates that an element of a first radio resource code vector associated with terminals included in an n^{th} terminal group includes information associated with an m^{th} first radio resource code. Hereinafter, it is assumed that the first terminal and the second terminal are included in the same terminal group. Accordingly, the same first radio resource code vector may be allocated to the first terminal and the second terminal.

Also,

w_{k,l}^{j}

indicates that an element of a second radio resource code matrix associated with a k^{th} terminal corresponds to a j^{th} transmit antenna, and an l^{th} second radio resource.

Referring to FIG. 4, radio resources are multiplexed with respect to a time slot and a frequency band. Hereinafter, the frequency band is referred to as a first radio resource and the time slot is referred to as a second radio resource.

Data 410 and 420 transmitted using the second radio resource corresponding to the time slot will be described with reference to FIG. 4. Each of the data 410 and 420 transmitted to a particular terminal using the second radio resource may use different vectors

w₁¹=[w_{1,1}¹, . . . , w_{1,4}¹]^{T}

and

w₂¹=[w_{2,1}¹, . . . , w_{2,4}¹]^{T}

included in the second radio resource code matrix, respectively. Specifically, the different vectors may be used for each transmit antenna of the particular terminal.

Hereinafter, data 430 and 440 transmitted using the first radio resource corresponding to the frequency band will be described with reference to FIG. 4. The data 430 and 440 transmitted to the particular terminal using the first radio resource may use the same first radio resource code vector

rₙ=[r_{n,1}, . . . , r_{n,M}]^{T}

.

When data is transmitted using a two-dimensional code division multiplexing scheme, data to be transmitted using each radio resource may be transmitted in a form where the first radio resource code vector and the second radio resource code matrix are multiplied with the data to be transmitted to each of the first terminal and the second terminal. Specifically, in the case of the data

d₁

to be transmitted to the first terminal, a code division multiplexing signal may be generated by multiplying the first radio resource, that is, the frequency band, and the second radio resource, that is, the time slot, by corresponding radio resource codes

r_{n,m}

and

w_{k,l}^{j}

.

According to an embodiment of the present invention, a different second radio resource code matrix may be determined with respect to each of terminals included in the same terminal group. Also, rows of each of second radio resource code matrices may correspond to a plurality of transmit antennas, respectively.

Referring to FIG. 5, rows of each of second radio resource code matrices associated with a first user and a second corresponds to a first transmit antenna and a second transmit antenna, respectively. Specifically, in FIG. 5,

w₁¹

denotes a first row of the second radio resource code matrix associated with the first user, and corresponds to the first transmit antenna.

w₁²

denotes a second row of the second radio resource code matrix associated with the first user, and corresponds to a second transmit antenna.

Also, rows

w₂¹

and

w₂²

of the second radio resource code matrix associated with the second user correspond to the first transmit antenna and the second transmit antenna, respectively.

In this case, the rows of the second radio resource code matrix associated with the particular terminal may be orthogonal to each other.

Here, the second radio resource code matrix with respect to a plurality of terminals included in the same terminal group is assumed. A plurality of rows corresponding to the same transmit antenna in each second radio resource code matrix may be orthogonal with respect to each other.

A condition of the aforementioned second radio resource code matrix may be expressed by the following Equation 1:

$${( {w}_{{k}_{1}}^{{j}_{1}} )}^{H} \cdot {w}_{{k}_{2}}^{{j}_{2}} = \{ \begin{matrix}c & {k}_{1} = {k}_{2} and {j}_{1} = {j}_{2} \\ 0 & otherwise\end{matrix} , \qquad ( 1 )$$

where

wₖ^{j}

denotes a row corresponding to a j^{th} transmit antenna in a second radio resource code matrix associated with a k^{th} user, and

C

denotes a constant.

According to another embodiment of the present invention, a correlation value of each of rows of a second radio resource code matrix associated with a particular terminal may be less than or equal to a predetermined reference value. Also, when second radio resource code matrices associated with a plurality of terminals included in the same terminal group are assumed, a correlation value of rows corresponding to the same transmit antenna in each second radio resource code matrix may be less than or equal to the predetermined reference value.

The condition of the aforementioned second radio resource code matrix may be expressed by the following Equation 2:

$${( {w}_{{k}_{1}}^{{j}_{1}} )}^{H} \cdot {w}_{{k}_{2}}^{{j}_{2}} = \{ \begin{matrix}c & {k}_{1} = {k}_{2} and {j}_{1} = {j}_{2} \\ a & otherwise\end{matrix} , \qquad ( 2 )$$

where

a

denotes a real number and has a relationship of

a<<c

.

FIG. 5 illustrates an example of generating a radio resource code matrix associated with a second radio resource when a two-dimensional code division multiplexing scheme is used according to an embodiment of the present invention.

Referring to FIG. 5, a row corresponding to a second transmit antenna in the second radio resource code matrix may be generated by modifying a row corresponding to a first transmit antenna. Here, it is assumed that a first row of the second radio resource code matrix corresponds to the first transmit antenna, and a second row of the second radio resource code matrix corresponds to the second transmit antenna. The second radio resource code generation unit 330 may generate elements of the second row of the second radio resource code matrix by changing locations of elements of the first row of the second radio resource code matrix or by changing a signs of the elements of the first row.

In addition to the above scheme shown in FIG. 5, the second radio resource code generation unit 330 may generate orthogonal rows of the second radio resource code matrix using another scheme.

That each row of the second radio resource code matrix generated according to the embodiment shown in FIG. 5 satisfies the condition of the above Equation 1 may be verified through the following Equation 3:

$$\{ \begin{matrix}{( {w}_{1}^{1} )}^{H} {w}_{1}^{1} = 4 \\ {( {w}_{1}^{1} )}^{H} {w}_{1}^{2} = 0 \\ {( {w}_{1}^{1} )}^{H} {w}_{2}^{1} = 0 \\ {( {w}_{1}^{1} )}^{H} {w}_{2}^{2} = 0\end{matrix} \{ \begin{matrix}{( {w}_{1}^{2} )}^{H} {w}_{1}^{1} = 0 \\ {( {w}_{1}^{2} )}^{H} {w}_{1}^{2} = 4 \\ {( {w}_{1}^{2} )}^{H} {w}_{2}^{1} = 0 \\ {( {w}_{1}^{2} )}^{H} {w}_{2}^{2} = 0\end{matrix} \\ \{ \begin{matrix}{( {w}_{2}^{1} )}^{H} {w}_{1}^{1} = 0 \\ {( {w}_{2}^{1} )}^{H} {w}_{1}^{2} = 0 \\ {( {w}_{2}^{1} )}^{H} {w}_{2}^{1} = 4 \\ {( {w}_{2}^{1} )}^{H} {w}_{2}^{2} = 0\end{matrix} \{ \begin{matrix}{( {w}_{2}^{2} )}^{H} {w}_{1}^{1} = 0 \\ {( {w}_{2}^{2} )}^{H} {w}_{1}^{2} = 0 \\ {( {w}_{2}^{2} )}^{H} {w}_{2}^{1} = 0 \\ {( {w}_{2}^{2} )}^{H} {w}_{2}^{2} = 4\end{matrix} \qquad ( 3 )$$

As the embodiment shown in FIG. 5, when the second row is generated by modifying the first row, there is no need to correct the first row. Specifically, a conventional system may be used as much as possible by using a radio resource code as is, used in an existing single transmit antenna, in correspondence to a first transmit antenna, and by using a radio resource code corresponding to a second transmit antenna through a modification of an existing code. Since there is no need to correct a conventional transmission scheme in order to apply the present invention, it is possible to reduce a time and costs to transmit data via a plurality of transmit antennas.

According to an embodiment of the present invention, the space-time coding unit 340 of FIG. 3 may generate a second data stream by multiplying a constant and transmission data included in a first stream, or by obtaining a conjugate complex of the transmission data included in the first data stream. Specifically, the space-time coding unit 340 may generate a second data stream by modifying the first data stream according to the following Equation 4 or Equation 5:

dₖ^{j}=b·dₖ¹ (4), and

dₖ^{j}=b·(dₖ¹)* (5),

where

dₖ¹

denotes the first data stream with respect to a k^{th} terminal,

dₖ^{j}

denotes a j^{th} data stream with respect to the k^{th} terminal, and

b

denotes a real number

FIG. 6 is a block diagram illustrating a structure of a terminal 600 to receive data transmitted using a code division multiplexing scheme according to an embodiment of the present invention. The terminal 600 may include a reception unit 610 and a decoding unit 620.

The reception unit 610 may receive a code division multiplexing signal from a base station 630. The code division multiplexing signal may be generated by multiplying a first radio resource code vector and a second radio resource code matrix by a plurality of data streams. The plurality of data streams may be generated by performing space-time encoding of transmission data associated with the terminal 600.

According to an embodiment of the present invention, the first radio resource code vector and the second radio resource code matrix may include information associated with a time slot for transmitting the code division multiplexing signal or a frequency band for transmitting the code division multiplexing signal.

The base station 630 may transmit the code division multiplexing signal via a plurality of transmit antennas included in a transmit antenna unit 640. A receive antenna unit 650 of the terminal 650 may include a single receive antenna or a plurality of receive antennas.

The decoding unit 620 may decode the code division multiplexing signal received from the base station 630 to the reception unit 610. The decoding unit 620 may decode the code division multiplexing signal based on the first radio resource code vector and the second radio resource code matrix.

According to an embodiment of the present invention, the reception unit 610 may receive the first radio resource code vector and the second radio resource code matrix from the base station 630. The decoding unit 620 may decode transmission data by multiplying the code division multiplexing signal by the first radio resource code vector and the second radio resource code matrix.

According to an embodiment of the present invention, the terminal 600 may be included in a particular terminal group together with a second terminal (not shown). The same first radio resource code vector may be allocated to all the terminals included in the particular terminal group. Specifically, the terminal 600 and the second terminal may use the same first radio resource code vector.

Also, a different second radio resource code matrix may be allocated to each of the terminals included in the particular terminal group. Specifically, each of the terminal 600 and the second terminal may use the different radio resource code matrix. For example, rows of the second radio resource code matrix associated with the terminal 600 may be orthogonal to rows of the second radio resource code matrix associated with the second terminal.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A transmission apparatus comprising:
a space-time coding unit to perform space-time encoding of transmission data to generate a plurality of data streams;
a radio resource code generation unit to generate a radio resource code vector by referring to radio resource allocation information associated with a reception apparatus;
a signal generation unit to generate a plurality of code division multiplexing signals corresponding to a plurality of transmit antennas, respectively, by multiplying the radio resource code vector and the plurality of data streams; and
a transmission unit to transmit the plurality of code division multiplexing signals to the reception apparatus via the plurality of transmit antennas.

2. The transmission apparatus of claim 1, wherein the plurality of data streams is orthogonal to each other.

3. The transmission apparatus of claim 1, wherein the space-time coding unit performs space-time encoding of the transmission data using an alamouti coding scheme.

4. The transmission apparatus of claim 1, wherein the radio resource allocation information includes information associated with a time slot for transmitting the plurality of code division multiplexing signals or a frequency band for transmitting the plurality of code division multiplexing signals.

5. A transmission apparatus comprising:
a grouping unit to determine, with respect to a reception apparatus accessing the transmission apparatus, a reception apparatus group including the transmission apparatus;
a space-time coding unit to perform space-time encoding of transmission data associated with the reception apparatus to generate a plurality of data streams corresponding to a plurality of transmit antennas, respectively;
a first radio resource code generation unit to allocate a first radio resource to the reception apparatus group and to generate a first radio resource code vector by referring to the first radio resource;
a second radio resource code generation unit to allocate a different second radio resource to each of the reception apparatus and a second reception apparatus that are included in the reception apparatus group, and to generate second radio resource code matrices by referring to the second radio resource;
a signal generation unit to generate a plurality of code division multiplexing signals corresponding to the plurality of transmit antennas, respectively, by multiply the plurality of data streams by the first radio resource code vector and the second radio resource code matrices associated with the reception apparatus; and
a transmission unit to transmit the plurality of code division multiplexing signals to the reception apparatus via the plurality of transmit antennas.

6. The transmission apparatus of claim 5, wherein each of the first radio resource and the second radio resource includes information associated with a time slot for transmitting the plurality of code division multiplexing signals and a frequency band for transmitting the plurality of code division multiplexing signals.

7. The transmission apparatus of claim 5, wherein:
rows of the second radio resource code matrices correspond to the plurality of transmit antennas, respectively, and
the rows are different from each other.

8. The transmission apparatus of claim 7, wherein the second radio resource code generation unit generates a second row of each of the second radio resource code matrices by changing locations of elements of a first row thereof, or by multiplying ‘−1’ and the elements of the first row.

9. The transmission apparatus of claim 7, wherein:
rows of the second radio resource code matrices associated with the reception apparatus are orthogonal to each other, or
rows of the second radio resource code matrix associated with the reception apparatus are orthogonal to rows of the second radio resource code matrix associated with the second reception apparatus, respectively.

10. The transmission apparatus of claim 7, wherein:
a correlation value of each of rows of the second radio resource code matrix associated with the reception apparatus is less than or equal to a predetermined reference value, or
the correlation value and a correlation value of each of rows of the second radio resource code matrix associated with the second reception apparatus are less than or equal to the reference value.

11. The transmission apparatus of claim 5, wherein:
the plurality of data streams includes a first data stream and a second data stream, and
the space-time coding unit generates the second data stream by multiplying a constant and transmission data included in the first data stream, or by obtaining a conjugate complex of the transmission data included in the first data stream.

12. The transmission apparatus of claim 5, wherein the signal generation unit maps the plurality of code division multiplexing signals corresponding to the plurality of transmit antennas in different physical resource blocks, respectively.

13. A reception apparatus comprised in a reception apparatus group, the reception apparatus comprising:
a reception unit to receive, from a transmission apparatus, a first radio resource code vector that is determined according to the reception apparatus group, and a second radio resource code matrix that is determined to be different from a second reception apparatus belonging to the reception apparatus group, and to receive a code division multiplexing signal that is transmitted via each of a plurality of transmit antennas of the transmission apparatus; and
a decoding unit to decode the code division multiplexing signal based on the first radio resource code vector and the second radio resource code matrix, wherein the code division multiplexing signal is generated by multiplying the first radio resource code vector and the second radio resource code matrix by a plurality of data streams that are generated by performing space-time encoding of transmission data associated with the reception apparatus.

14. The reception apparatus of claim 13, wherein each of the first radio resource code vector and the second radio resource code matrix includes information associated with a time slot for transmitting the code division multiplexing signal or a frequency band for transmitting the code division multiplexing signal.

15. The reception apparatus of claim 13, wherein the decoding unit decodes the transmission data associated with the reception apparatus by multiplying the code division multiplexing signal by the first radio resource code vector and the second radio resource code matrix.

16. The reception apparatus of claim 13, wherein rows of the second radio resource code matrix associated with the reception apparatus are orthogonal to rows of the second radio resource code matrix associated with the second reception apparatus, respectively.
